(19) United States
(12) Patent Application Publication
(10) Pub. No.: US 2002/0160339 A1
(43) Pub. Date: Oct. 31, 2002

(54) Matchmaking search system

(76) Inventors: Walter King, New York, NY (US); Borislav Mezhericher, Kew Gardens, NY (US)

Correspondence Address: NOBLE GRACE LLC, 826 COLUMBUS AVENUE, SUITE 2-G, NEW YORK, NY, 10025, US

(21) Appl. No.: 10/099,125

(22) Filed: Feb. 9, 2002

Related U.S. Application Data
(63) Continuation-in-part of application No. 09/788,010, filed on Feb. 16, 2001.

(51) Int. Cl. G09B 19/00

(52) U.S. Cl. 434/106

(57) ABSTRACT

A method and system of matchmaking search based on people's combined astrological compatibility, which is calculated as a weighted average of people's compatibilities under different astrological teachings. The matchmaking is accomplished by constructing a table of combined compatibility and allowing people to search various data sources based on this combined compatibility. Each pair of combined astrological signs within the table is assigned a combined compatibility number depending on astrological compatibility of the people within this pair. The method and software program, are based on Western and Chinese combined, cross-referenced astrological compatibility charts.

### RELATED APPLICATIONS

This application is a continuation in part of the U.S. patent application Ser. No. 09/788,010, filed on Feb. 16, 2001, and claims all rights of priority thereto.

### FIELD OF THE INVENTION

The invention is generally related to the field of online and offline dating and matchmaking according to astrological compatibility between people. More specifically, the present invention relates to the method and system for searching various on-line and off-line data sources for a person's best astrologically compatible match.

### BACKGROUND INFORMATION

Relationship Astrology is based on these two major principles: How individual of particular person formed and develops depends to some degree on the following factors: his place, day, month, year, hour and minute of birth. These factors are directly responsible for forming a combination of astrological characteristics of this person. Some major astrological characteristics of the person are also called his astrological signs. There are many astrological signs that every person has. For example, every person has Chinese Year or Animal sign, Western Month or Zodiac sign, Vedic Sign, Moon sign, Rising Sign etc. For the sake of simplicity, let's call the unique combination of person's astrological characteristics his “MultiSign”. How particular person is compatible with another person in love, work and other life activities depends on how these two MultiSigns compatible with each other.

There are two major astrological systems or traditions that are currently in most advanced stage of development: Western Astrology and Chinese Astrology.

In Western astrology, main characteristics of a person are in some extent determined by his/her Zodiac (or Sun) Sign. Zodiac Sign of a person is established by one of 12 constellations in which the Sun was located when the person was born. There are twelve Zodiac Signs in Western Astrology: Aries, Taurus, Gemini, Cancer, Leo, Virgo, Libra, Scorpio, Sagittarius, Capricorn, Aquarius, and Pisces. Former president Bill Clinton, for example, was born on August 19, when the Sun was in the constellation of Leo. Accordingly his Zodiac Sign is Leo. People born under sign of Leo are believed to be courageous, generous and responsible. According to Western astrological tradition Leo is most compatible with Aries and Sagittarius, and does not get along with Capricorn. Among famous people born under the Western Zodiac sign of Leo are Robert Redford, Alfred Hitchcock, Jacqueline Kennedy-Onassis, Napoleon Bonaparte.

In Chinese astrology, every year is believed to be governed by one of twelve legendary animals. Every such “Animal Year” determines main character traits of people born within this year. The twelve animals are Rat, Ox, Tiger, Rabbit, Dragon, Snake, Horse, Goat, Monkey, Rooster, Dog, and Pig. To continue the example of former president Bill Clinton, who was born in 1946, that year was the Year of the Dog according to Chinese Astrology. Consequently, his Animal Sign according to Chinese astrology is Dog, or as it is traditionally said, Mr. Clinton was born in The Year of Dog. People born in the Year of Dog are believed to be loyal, trustworthy, friendly, kind and unselfish. According to Chinese astrological tradition Dogs are most compatible with Tigers and Horses, but do not get along with Dragons. Among famous people born in the Chinese astrological Year of Dog are Elvis Presley, Michael Jackson, Sharon Stone, Winston Churchill, President George W. Bush.

Traditional Western astrology books (as well as Chinese, Vedic and most of other conventional astrological systems) describe how, for example, how Gemini gets along with Scorpio, or Rooster with Snake, etc. Relationships are described as “balanced”, “difficult, but possible”, “compatible and stable”, “you are lucky to find each other” and in similar ways with great detail—sometime up to 5-6 book pages regarding every possible pair. Sometimes those descriptions are expressed as rating numbers, like, for instance, 10 (ten) for the best compatible pair and 0 (zero) for the least compatible. The above-mentioned examples, when compatibility is numerically rated, or, in other words, expressed in rating numbers, are instances of one-dimensional compatibility.

One-dimensional compatibility is a numerically expressed compatibility between two signs in conventional astrological system. For example, compatibility between Cancer and Libra in Western astrology or between Tiger and Dragon in Chinese astrology would fall under this definition.

In this explanation we'll talk not only about one-dimensional, but rather about two- and multi-dimensional compatibilities.

Multi-dimensional compatibility between two people can be defined as weighted average [or otherwise calculated balance] of one-dimensional compatibilities between these two persons' MultiSigns.

In this explanation we'll use example of Double Astrology. Double Astrology is the first revolutionary blend of two conventional (Chinese and Western) astrological traditions. For a long time world astrologers were divided as followers of the Western, the Chinese, Vedic, Celtic or other astrological schools. Therefore, a person was considered to be a representative of either 12 Western Sun Signs or 12 Chinese Animals, depending on the school a particular astrologer followed. Recently, however, leading astrologers of both schools started a movement towards blending the two systems. Now, it is more and more widely believed that every person is a representative of one of 144 (12×12) astrological combinations, each of these combinations being a person's sun sign (determined by his/her lunar month of birth) and animal sign (determined by his/her lunar year of birth). So, Mr. Clinton's astrological sign is considered to be not just a Leo, as Western astrologers would believe, or a Dog, as Chinese astrologers would believe, but a combination of these two, i.e., the Leo/Dog. Therefore, another person born in the same Chinese Astrological Year of Dog, but under different Western Sign (say Gemini), will be characterized by a different DoubleSign—Dog/Gemini. The above system will result in 12 combined signs for each animal year, thus resulting in 144 astrological combinations.

In recent years Chinese and Western astrological systems are being integrated into Double Astrology. This breakthrough integration of two most popular astrological systems dramatically changed the approach to assessment of compatibility between signs and even the core meaning of term Astrological Sign of the individual. These days the individual is perceived not as one dimensional one sign carrier, but rather a representative of DoubleSign (unique combination of Chinese Animal and Western Sun signs) or even as MultiSign (combination of Chinese Animal Sign, Chinese Element, Chinese Hour of Birth Sign, Western Sun Sign, Western Moon Sing, Western Rising Sign and more). This is a progress in accepting and understanding person's complex and unique personality balance.

When typical astrological tradition like, for instance, Western or Chinese, sees person as one out of 12 signs (12 is a prevalent number of signs in most astrological systems), the Double Astrology sees person as a unique blend of two astrological signs (Chinese Year & Western Month Signs). This incorporation of two astrological signs is called DoubleSign. Incorporation of more than two person's astrological signs is called MultiSign.

When in within one astrological tradition like Western or Chinese we find total of 12 signs—there will be 144 possible combinations of those signs. For example: Aries with Aries, Aries with Taurus, Aries with Gemini, . . . Taurus with Aries, Taurus with Taurus, Taurus with Gemini, . . . Gemini with Aries, Gemini with Taurus, Gemini with Gemini, etc. If we don't count repetitive combinations like, for example, Aries with Gemini and Gemini with Aries, we end up with less than 144 combinations. The number is 78.

When the two astrological systems are combined together, there are 144 (12 Western×12 Chinese) combined signs, that in turn creates 20,736 combinations, or 6,084 (78×78) ways to make a unique, non-repetitive pair. Each individual pair will have its own compatibility rating. By reducing these compatibility ratings to numeric or percentage terms and organizing them into a combined compatibility table, a new method of studying peoples' compatibility is created. In addition to studying the compatibility, this method may be used for matchmaking, i.e., finding astrologically compatible partners. Many matchmaking services focus only on traditional criteria, such as age, religion, build, hair color, etc. While these are very important factors in people's relationships, often people can't get along even if they satisfy each other's traditional, or stereotypical, criteria of an ideal match. Some matchmaking services include person's astrological sign (mostly Western) as one of this person's characteristics, but they do not allow people to search for each other based on their combined astrological signs. More importantly, none of the existing matchmaking systems calculates a combined astrological compatibility between partners or allows its database to be searched based on the combined compatibility criteria.

Additionally, there is currently no uniform system for people to search for their compatible match using various available databases. Thus, a person looking for an astrological match can search only databases of astrology-related websites. However, there is no tool, which would allow this person to enter his/her criteria and then perform a global search of all databases to find an astrological match.

### SUMMARY OF THE INVENTION

It is an object of the present invention to provide a method and system for determining people's combined astrological compatibility.

It is also an object of the present invention to provide a method and a system for performing a global search of all available data sources for an astrological match.

It is another object of the present invention to provide a method and a searching tool allowing a user to perform search of data sources for possible partners based on a combined astrological compatibility rating.

It is a further object of the present invention to provide a method and system for determining people's combined astrological compatibility by constructing a table of such combined compatibility.

It is still a further object of the present invention to provided handheld devices, gaming appliances and other apparatuses that will allow people to search for partners by using the combined astrological compatibility.

Further objects and/or advantages of the invention will become apparent in conjunction with the disclosure herein.

To accomplish the above-enumerated objects, the present invention provides a method and system of matchmaking based on people's combined astrological compatibility. The matchmaking is accomplished by constructing a table of combined compatibility and allowing people to search a provided database, as well as other data sources available both on-line and off-line, based on this combined compatibility. Each pair of MultiSigns within the table is assigned a combined compatibility number depending on astrological compatibility of the people within this pair. Compatibility table of combined astrological signs, consisting of 144 rows and 144 columns, allow its user to determine how different combined signs are astrologically compatible.

### BRIEF DESCRIPTION OF THE DRAWINGS

A full understanding of the invention can be gained from the following description of the preferred embodiments when read in conjunction with the accompanying drawings in which:

FIG. 1 is a preferred embodiment of the home page interface of a website presented in accordance with the present invention;

FIG. 2 is a preferred embodiment of the sign calculator query interface in accordance with the present invention;

FIG. 3 is a preferred embodiment of the sign calculator results interface in accordance with the present invention;

FIG. 4 is a preferred embodiment of the registration interface in accordance with the present invention;

FIG. 5 is a preferred embodiment of the login interface in accordance with the present invention;

FIG. 6 is a preferred embodiment of the combined compatibility query interface in accordance with the present invention;

FIG. 7 is a preferred embodiment of the compatibility results interface in accordance with the present invention;

FIG. 8 is a preferred embodiment of the search query interface in accordance with the present invention;

FIG. 9 is a preferred embodiment of the search results interface in accordance with the present invention;

FIG. 10 is a flow diagram of the searching algorithm in accordance with the preferred embodiment of the present invention;

FIG. 11 is a flow diagram of the algorithm for calculating a combined astrological compatibility of two people, performed as part of the search algorithm shown in FIG. 10, in accordance with the preferred embodiment of the present invention;

FIG. 12 is a flow diagram of the combined compatibility algorithm for calculating a combined astrological compatibility of two people whose data is entered into the system by the user;

FIG. 13 is a schematic diagram of a basic search system utilized by the present invention;

FIG. 14 is a schematic diagram of an advanced search system utilized by the present invention;

FIG. 15 is a flow diagram of the basic search performed in one embodiment of the present invention; and

FIG. 16 is a flow diagram of the advanced search performed in one embodiment of the present invention.

### DETAILED DESCRIPTION OF THE PREFERRED EMBODIMENTS AND THE DRAWINGS

The following Detailed Description describes the invention in connection with the compatibility calculating software and astrological matchmaking already partially implemented at NobleGrace.com, the web site containing astrological compatibility and matchmaking materials and a database of people looking for a compatible partner. The disclosed method and system for searching various data sources for a person's astrological match is also partially implemented in a MatchSpider™ software available from NobleGrace.com. It is to be understood, however, that the presently disclosed and claimed methods and systems of matchmaking, searching and determining astrological compatibility can be implemented as a stand alone application, or as an application on a handheld portable gaming device, or even without utilizing a computer, for example, as a flash cards system.

In the preferred embodiment of the present invention an Internet website is provided which allows people to calculate their MultiSign compatibility with their partners or, alternatively, to search a website's database for an astrologically compatible partner. This system preferably has a database management system. In the preferred embodiment, the Apache web server and MySQL database are used. The website may be accessed by using desktop computer, handheld computer, WebTV, wireless device or any other Internet appliance through a dial-up Internet Service Provider, DSL, company LAN, wireless connection, etc. The provided website utilizes a software tool, or calculator, which calculates the combined astrological compatibility between signs. The calculator software used in the preferred embodiment is the NobleGrace® Compatible By Horoscope Calculator available from NobleGrace.com.

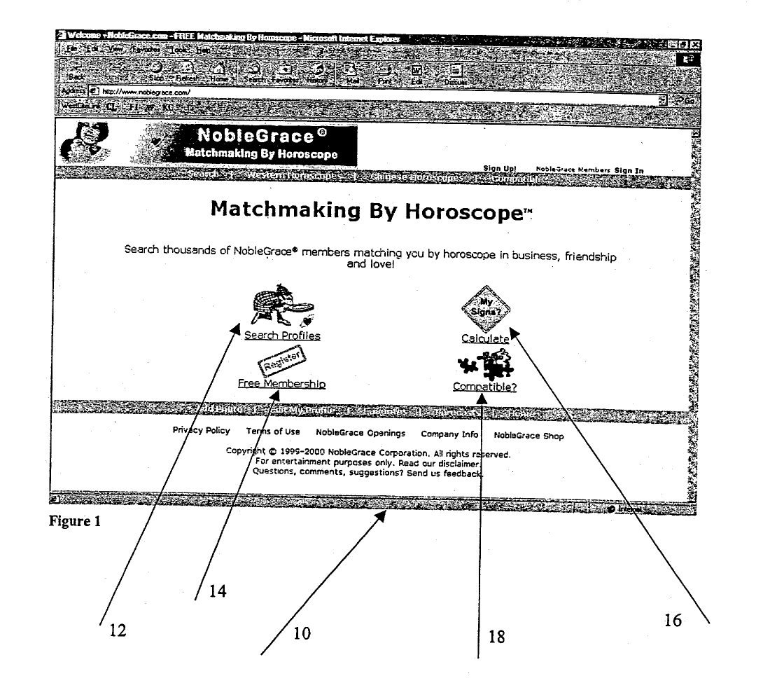

The preferred embodiment of the method and system for astrological matchmaking and determining astrological compatibility of partners based on their Western and Chinese astrological signs is illustrated in FIGS. 1-11. As shown in FIG. 1, each user starts the process by accessing a home page 10 of the provided website. The home page 10 preferably provides a search page link 12, allowing the user to access a search page, a registration link 14, allowing the user to access a registration page, a sign calculator link 16 and a compatibility calculator link 18.

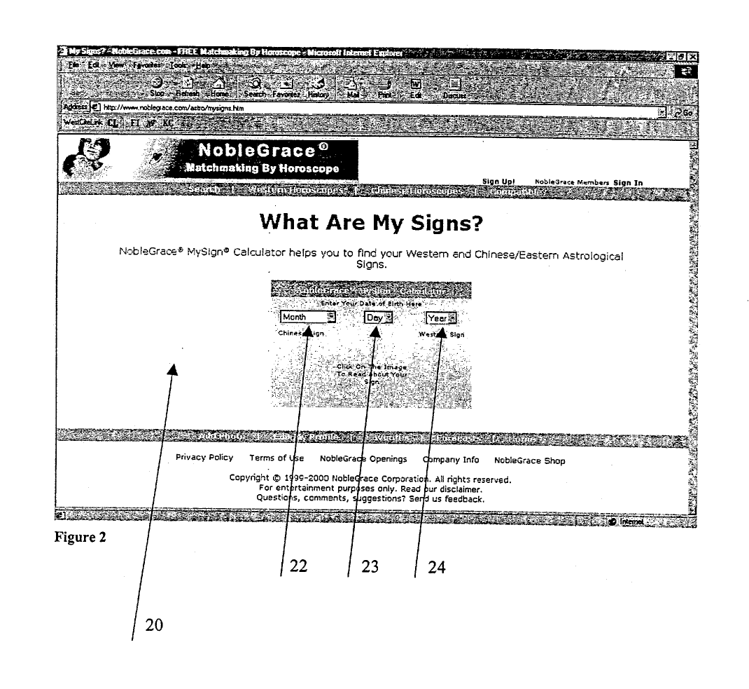

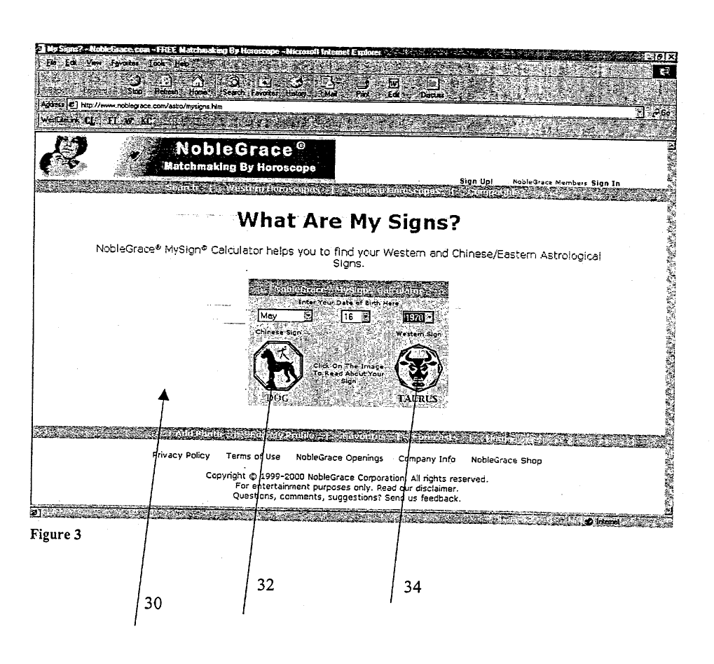

As shown in FIG. 2, by selecting the sign calculator link 16, the user will access the sign calculator query interface 20. In the preferred embodiment of the invention, the sign calculator interface allows the user to enter his/her month, day and year of birth in the provided fields 22-24, respectively. The user's day and month of birth will determine the Western, i.e., sun sign, and the user's year of birth (or more specifically, his/her lunar year of birth) will determine the Chinese, i.e., animal sign. After the user's signs are determined they are preferably displayed in a sign calculator results interface 30, shown in FIG. 3. Images of the Chinese and Western signs of the user will preferably appear in this interface. By selecting either the Chinese sign image 32 or the Western sign image 34, the user may access an individual sign interface (not shown). Each individual sign interface preferably contains a short description of qualities and personal character traits associated with a particular sign (both Chinese and Western).

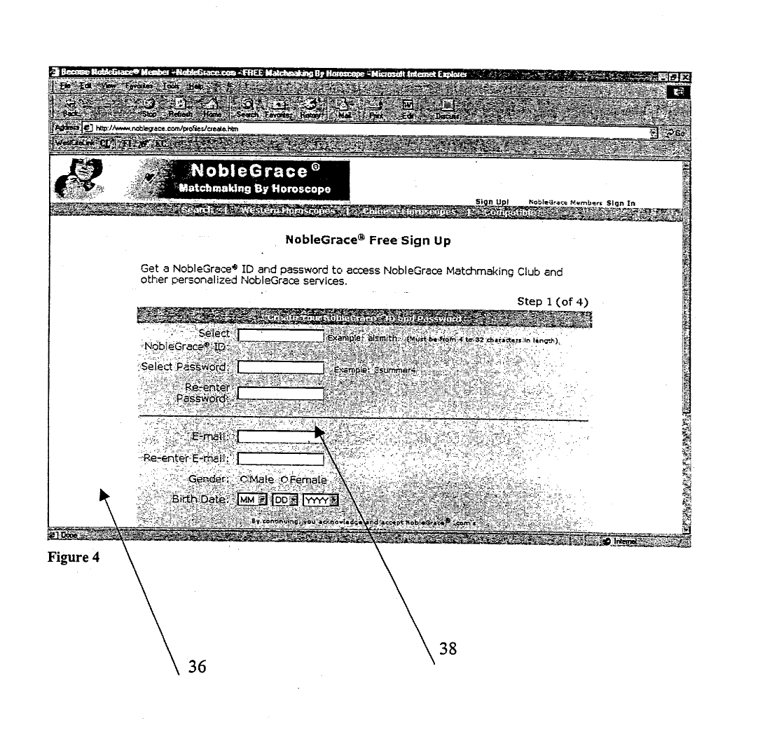

In accordance with the preferred embodiment of the present invention, users may be registered in a database associated with the website in order to be able to search the database or to determine their compatibility with their partners. The registration is preferably accomplished by accessing a registration interface 36, shown in FIG. 4, and filling out a questionnaire 38 by entering the required information into the appropriate fields. This information is then stored in the database. The registration interface may be accessed, for example, from the home page 10 by selecting the registration link 14. During the registration, a user will select his/her username and password that will be unique to this particular user and will identify him/her to the system. The system will preferably send an E-mail to the user after the registration with his/her username and password.

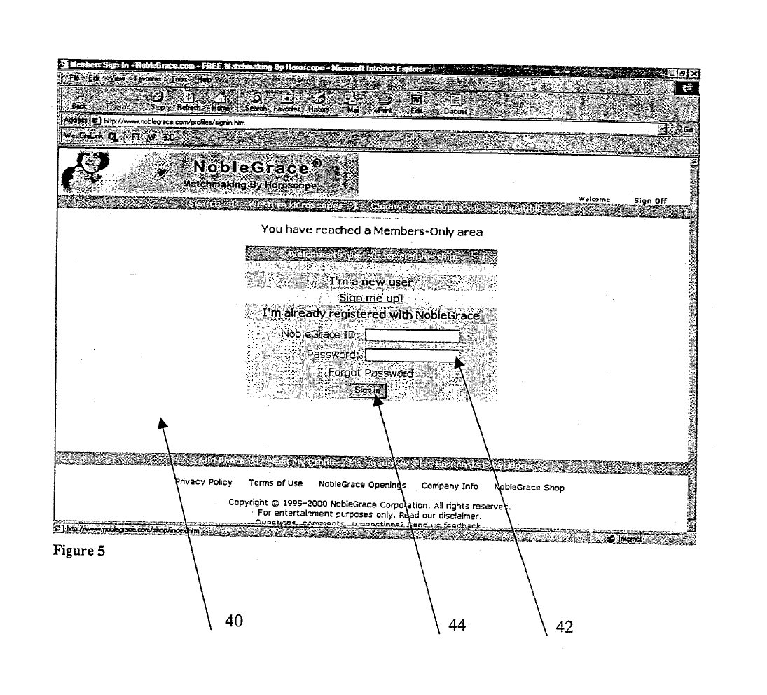

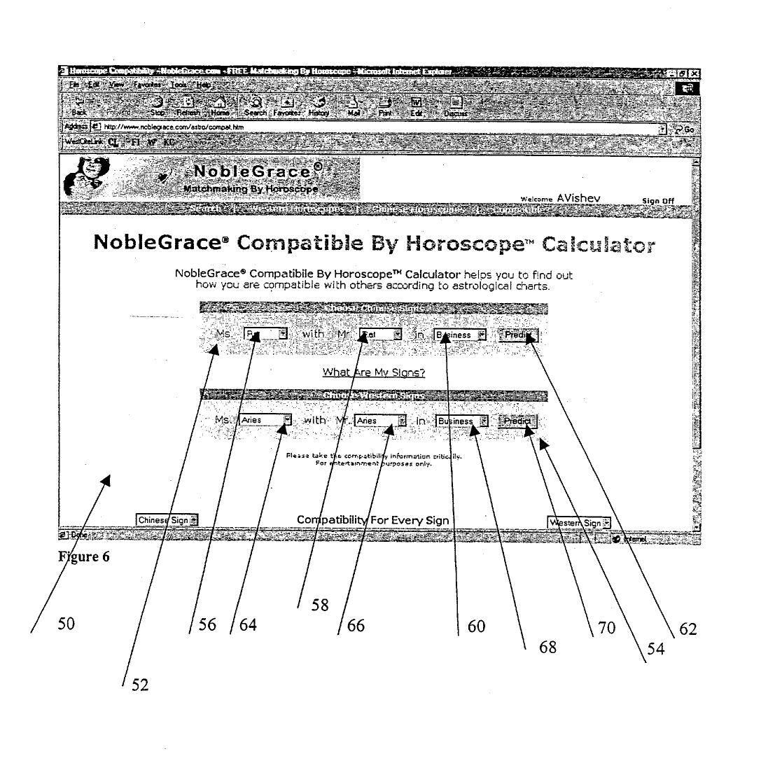

Alternatively, if a user is already registered, he or she may access the “members only” content by entering the username and password into the appropriate fields 42 and selecting the “Sign in” button 44 at the login interface 40, shown in FIG. 5.

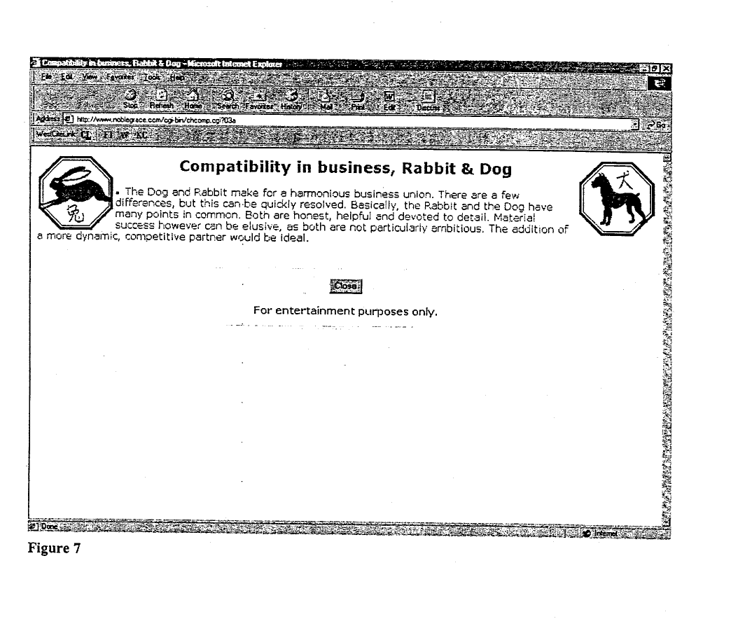

In accordance with the preferred embodiment of the present invention, a compatibility calculator is provided, where users may calculate their compatibility with their partners based on their astrological signs. As shown in FIG. 6, registered users may access the combined compatibility query interface 50. The interface 50 preferably has a Chinese signs query 52 and a Western signs query 54. In order to determine partners' Chinese compatibility, their signs should be selected from the scroll bars 56 and 58 containing all Chinese animal signs. One of the above scroll bars preferably corresponds to a female partner (scroll bar 56 in the embodiment shown in FIG. 6) and another scroll bar corresponds to a male partner (scroll bar 58 in the embodiment shown in FIG. 6). Of course, these scroll bars may be made gender neutral. The third scroll bar 60 within the Chinese signs query 52 allows the user to select the type of relationship between the partners, for example, love, friendship, business, etc. After the appropriate information is selected in the scroll bars 56, 58, and 60, the user may activate a Chinese compatibility algorithm by clicking on the “predict” button 62. Similarly to the above, the Western query 54 has two Sun signs scroll bars 64 and 66 and a third scroll bar 70 indicating the relationship between partners. By clicking on the “predict” button 70, the user may activate a Western compatibility algorithm. In order to determine a combined astrological compatibility of the partners, the user will select a combined compatibility link (not shown), which will activate a combined compatibility calculator algorithm.

The Chinese compatibility algorithm will compare the Chinese signs of the partners, selected in the scroll bars 56 and 58, to the Chinese compatibility table, shown herein as Table I. The Chinese compatibility table has 12 rows, corresponding to 12 Chinese animal signs, and 12 columns, also corresponding to the 12 animal signs. Each number, located in a cell at an intersection of one row and one column, indicates a numerical compatibility between the two Chinese animal signs (one from the row heading and another from the column heading). For example, the compatibility between two partners, one of which is a Rooster and another is a Tiger, equals to 1. In the preferred embodiment, “1” corresponds to the lowest possible compatibility, i.e. “highly incompatible,” and “8” corresponds to the highest possible compatibility, i.e., “highly compatible.” These numbers are determined based on various empirical studies and teachings of different astrologers. Of course, different numbers or various percentage terms may be selected to represent this compatibility.

TABLE I
Chinese Signs Compatibility Chart

| | Rat | Ox | Tiger | Rabbit | Dragon | Snake | Horse | Goat | Monkey | Rooster | Dog | Pig |
|---|---|---|---|---|---|---|---|---|---|---|---|---|
| Rat | 7 | 7 | 4 | 6 | 8 | 1 | 6 | 1 | 8 | 5 | 6 | 6 |
| Ox | 7 | 6 | 3 | 6 | 6 | 8 | 1 | 6 | 1 | 8 | 3 | 5 |
| Tiger | 4 | 3 | 6 | 4 | 6 | 3 | 8 | 1 | 6 | 1 | 8 | 7 |
| Rabbit | 6 | 6 | 4 | 7 | 6 | 6 | 3 | 8 | 1 | 6 | 1 | 8 |
| Dragon | 8 | 6 | 6 | 6 | 7 | 7 | 6 | 6 | 8 | 1 | 6 | 1 |
| Snake | 1 | 8 | 4 | 6 | 7 | 7 | 3 | 4 | 3 | 8 | 1 | 6 |
| Horse | 6 | 1 | 8 | 3 | 6 | 3 | 7 | 7 | 4 | 5 | 8 | 1 |
| Goat | 1 | 6 | 1 | 8 | 6 | 4 | 7 | 7 | 4 | 4 | 3 | 8 |
| Monkey | 8 | 1 | 6 | 1 | 8 | 3 | 4 | 4 | 7 | 4 | 6 | 6 |
| Rooster | 5 | 8 | 1 | 6 | 1 | 8 | 5 | 4 | 4 | 3 | 4 | 4 |
| Dog | 6 | 3 | 8 | 1 | 6 | 1 | 8 | 3 | 6 | 4 | 6 | 6 |
| Pig | 6 | 5 | 7 | 8 | 1 | 6 | 1 | 8 | 6 | 4 | 6 | 6 |

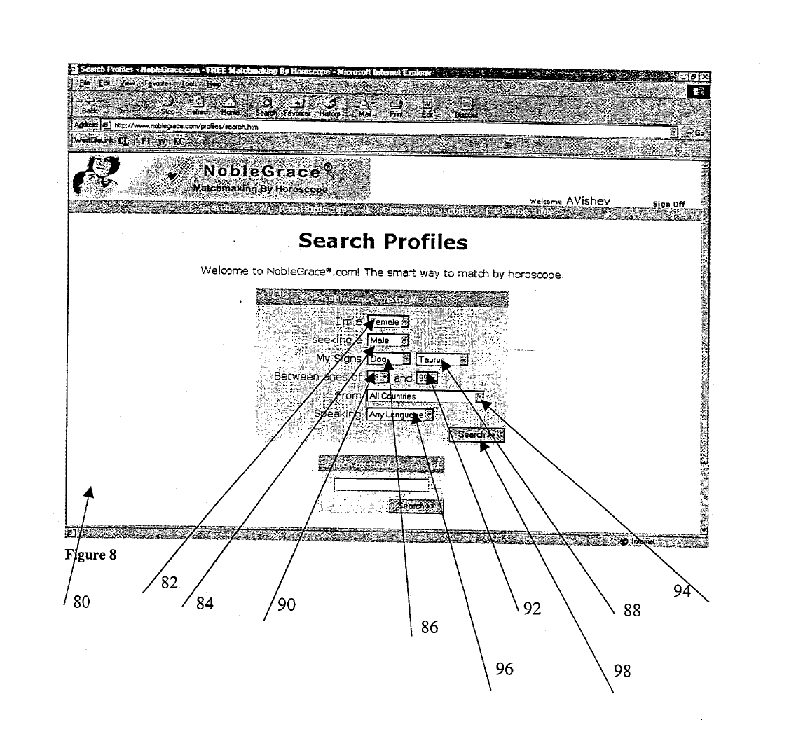

When the compatibility number is found, the algorithm will preferably display it to the user in the compatibility results interface. Additionally, a short description may accompany the displayed number, as shown for example in FIG. 7 (the description is shown without a compatibility number).

Similarly to the above described Chinese compatibility algorithm, the Western compatibility algorithm will compare the Sun signs of the partners, selected in the scroll bars 64 and 66, to the Western compatibility table, shown herein as Table II.

TABLE II
Western Signs Compatibility Chart

| | Aries | Taurus | Gemini | Cancer | Leo | Virgo | Libra | Scorpio | Sagittarius | Capricorn | Aquarius | Pisces |
|---|---|---|---|---|---|---|---|---|---|---|---|---|
| Aries | 7 | 7 | 4 | 6 | 8 | 6 | 1 | 4 | 8 | 5 | 6 | 6 |
| Taurus | 7 | 6 | 3 | 6 | 6 | 8 | 5 | 1 | 4 | 8 | 3 | 5 |
| Gemini | 4 | 3 | 6 | 4 | 6 | 3 | 8 | 4 | 1 | 5 | 8 | 7 |
| Cancer | 6 | 6 | 4 | 7 | 6 | 6 | 3 | 8 | 5 | 1 | 7 | 8 |
| Leo | 8 | 6 | 6 | 6 | 7 | 7 | 6 | 6 | 8 | 7 | 1 | 6 |
| Virgo | 6 | 8 | 4 | 6 | 7 | 7 | 3 | 4 | 3 | 8 | 6 | 1 |
| Libra | 1 | 5 | 8 | 3 | 6 | 3 | 7 | 7 | 4 | 5 | 8 | 6 |
| Scorpio | 4 | 1 | 4 | 8 | 6 | 4 | 7 | 7 | 4 | 4 | 3 | 8 |
| Sagittarius | 8 | 4 | 1 | 5 | 8 | 3 | 4 | 4 | 7 | 4 | 6 | 6 |
| Capricorn | 5 | 8 | 5 | 1 | 7 | 8 | 5 | 4 | 4 | 3 | 4 | 4 |
| Aquarius | 6 | 3 | 8 | 7 | 1 | 6 | 8 | 3 | 6 | 4 | 6 | 6 |
| Pisces | 6 | 5 | 7 | 8 | 6 | 1 | 6 | 8 | 6 | 4 | 6 | 6 |

The Western compatibility table has 12 rows and 12 columns, corresponding to 12 Sun signs. Similarly to the Chinese compatibility table, each number, located in a cell at an intersection of one row and one column, indicates a numerical compatibility between the two Sun signs (one from the row heading and another from the column heading). For example, the compatibility between two partners, one of which is a Scorpio and another is a Taurus, equals to 1. Again, “1” corresponds to the lowest possible compatibility, i.e. “highly incompatible,” and “8” corresponds to the highest possible compatibility, i.e., “highly compatible.” The compatibility number and a short description of the compatibility between partners may then be displayed by the algorithm to the user in a separate interface (not shown).

A combined astrological compatibility calculator is based on a combined compatibility algorithm. As shown in FIG. 12, this algorithm will start at block 100 and will first determine a couple's Chinese compatibility, utilizing the above described Chinese compatibility table, step 102. The algorithm will then proceed to determine the couple's Western compatibility, using the above described Western compatibility table, step 103. Couple's combined astrological compatibility may then be found as a weighted average of the Western and Chinese compatibilities, step 104, in accordance with the following formula:

Combined Compatibility=Western Compatibility×Western Weight+Chinese Compatibility×Chinese Weight, Equation 1.1

where

Western Compatibility—compatibility between signs according to Western Astrology;

Chinese Compatibility—compatibility between signs according to Chinese Astrology;

Western Weight relative importance of Western Compatibility; and

Chinese Weight—relative importance of Chinese Compatibility.

In the preferred embodiment, the relative weight of the Chinese compatibility is preferably 75% and relative weight of the Western compatibility is preferably 25%. Thus, if compatibility between Taurus and Capricorn according to Western astrology is “8” or 100% in percentage terms, and compatibility between Ox and Horse according to Chinese astrology is “1” or 20% in percentage terms, then the combined astrological compatibility between Ox/Taurus and Horse/Capricorn is 40% (100%*0.25+20%*0.75=40%). The calculated combined astrological compatibility is then displayed to the user, step 105. In addition to the Western and Chinese compatibilities, the combined astrological compatibility may include people's rising signs and other astrological characteristics and non-astrological characteristics, by assigning their relative weights and adding them to the above formula.

Instead of entering the Chinese and Western astrological signs into the scroll bars 56, 58, 64, and 66, the user may enter birthdays of the partners and allow the algorithm to determine these signs, by comparing the entered birthdays to an internal calendar. The entered dates of birth may also be used by the algorithm to determine various other astrological characteristics, for example, people's rising signs. These calculations will preferably be performed on the background. The determined characteristics are preferably stored in a database as a person's astrological profile. For example, if a person provides a date of birth “12/20/81”, some of the astrological data recorded will be “Rooster” (Chinese animal sign) and “Sagittarius” (Western Sun sign). It is to be understood that the above described algorithm may be used separately from the described website, as a standalone application, for example.

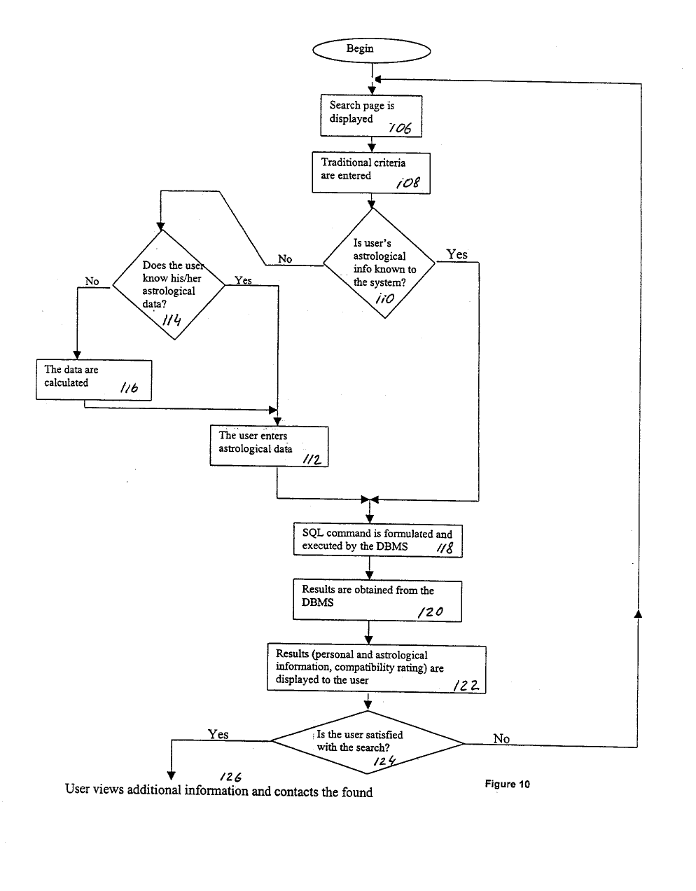

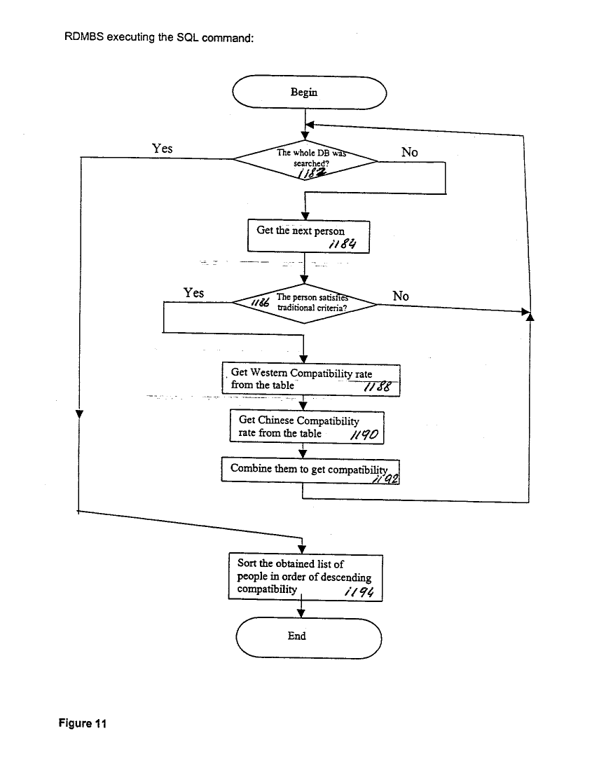

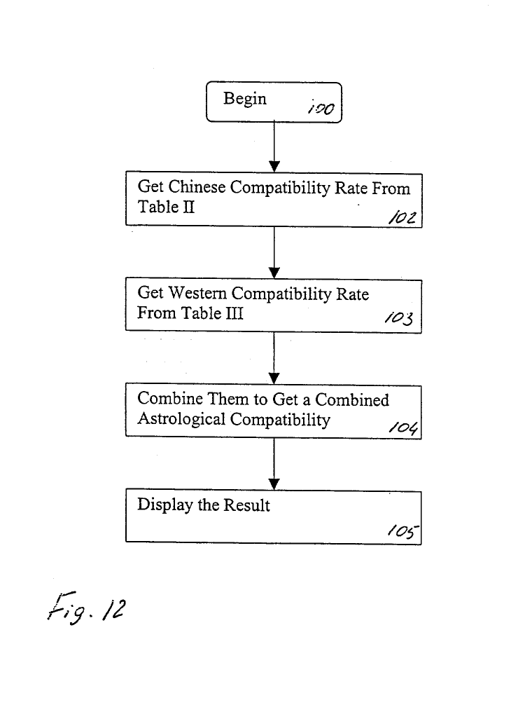

In another aspect of the preferred embodiment of the present invention, one registered user may search a provided database to find a compatible match. The preferred embodiment of the searching algorithm is shown in FIGS. 10 and 11. The user may access a search query interface 80, shown in FIG. 8, by selecting a “Search Profiles” link 12 on the home page 10. See step 106, FIG. 10. The search query interface preferably allows the user to enter a variety of traditional search criteria such as age, country, language, etc (step 108, FIG. 10). If the user knows his/her astrological signs (step 114, FIG. 10), the search interface also allows the user to enter the required astrological information, step 112. In the preferred embodiment shown in FIG. 8, eight scroll bars are provided, allowing the user to select his/her gender, scroll bar 82, gender of a potential partner, scroll bar 84, user's Chinese sign, scroll bar 86, user's Western sign, scroll bar 88, potential partner's age boundaries, scroll bars 90 and 92, user's country, scroll bar 94, and user's language, scroll bar 96. If the astrological information is already known to the system, step 110, (i.e., user is a registered member), this information will be extracted from the database and filled in automatically. Should the user not know his/her astrological information, there is an option to enter the user's date of birth and to calculate all relevant data, step 116, by following a link “My signs?” (not shown). After all information is entered, the user may activate the searching algorithm by clicking on the “Search” button 98.

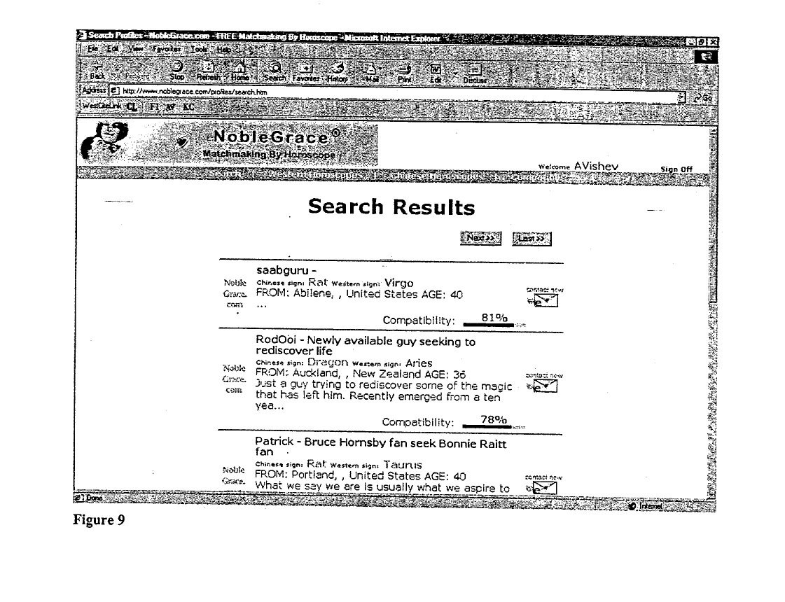

When the user clicks on the “search” button, the information is passed to the processing program. This program, based on these data, formulates a command (query) in SQL program language, step 118, and tells the database management system (in our case, MySQL) to execute it. Results are then obtained from the database management system, step 120, and displayed to the user, step 122, in a search results interface 200, shown in FIG. 9. If the user is satisfied with the obtained results, step 124, he/she may view additional information for each found match, step 126, or, alternatively, the user may perform the search again.

The execution step 118 is more particularly shown in FIG. 11. In order to execute the formulated query, the algorithm first determines whether the entire database was searched, step 1182. If the database was not search fully, the algorithm will select a new person within the database, step 1184. If the selected person satisfies the traditional criteria entered by the user, step 1186, the algorithm determines the Western compatibility rate, step 1188, and the Chinese compatibility rate, step 1190, and combines them in accordance with the above formula (see Equation 1.1) to determine the combined astrological compatibility, step 1192, between the selected person and the user. The process is then repeated for all people within the database. Specifically, the database management system selects all people that match traditional criteria (age, country, etc.); and for each selected person, it calculates the person's compatibility with the searching user, using compatibility tables for both Chinese & Western astrological data, and combining the two compatibility rates by using the above weighted-average formula. After the algorithm finishes searching through the database, it sorts the results in order of descending compatibility (that is, 100% compatible person is the first on the list), step 1194. Having sorted the information, the DBMS (Database Management System) stops executing the query and returns the result (selected people) to the processing program.

In an alternative preferred embodiment of the present invention, all Chinese/Western combined astrological compatibilities may be pre-calculated based on the provided individual compatibilities between Chinese animal signs, as shown in Table I, and provided individual compatibilities between Western Sun signs, as shown in Table II, in accordance with the formula given above. (see Equation 1.1) The resulting combined compatibilities may be entered into a 144×144 table of combined compatibilities, an excerpt of which is shown in Table III below.

TABLE III
Combined Astrological Compatibilities (Excerpt)

| | Rat/Aries | Rat/Taurus | Rat/Gemini | Rat/Cancer | Rat/Leo | Rat/Virgo |
|---|---|---|---|---|---|---|
| Rat/Aries | 7.00 | 7.00 | 6.25 | 6.75 | 7.25 | 5.50 |
| Rat/Taurus | 7.00 | 6.75 | 6.00 | 6.75 | 6.75 | 7.25 |
| Rat/Gemini | 6.25 | 6.00 | 6.75 | 6.25 | 6.75 | 6.00 |
| Rat/Cancer | 6.75 | 6.75 | 6.25 | 7.00 | 6.75 | 6.75 |
| Rat/Leo | 7.25 | 6.75 | 6.75 | 6.75 | 7.00 | 7.00 |
| Rat/Virgo | 5.50 | 7.25 | 6.25 | 6.75 | 7.00 | 7.00 |
| Rat/Libra | 6.75 | 5.50 | 7.25 | 6.00 | 6.75 | 6.00 |
| Rat/Scorpio | 5.50 | 6.75 | 5.50 | 7.25 | 6.75 | 6.25 |
| Rat/Sagittarius | 7.25 | 5.50 | 6.75 | 5.50 | 7.25 | 6.00 |
| Rat/Capricorn | 6.50 | 7.25 | 5.50 | 6.75 | 5.50 | 7.25 |
| Rat/Aquarius | 6.75 | 6.00 | 7.25 | 5.50 | 6.75 | 5.50 |
| Rat/Pisces | 6.75 | 6.50 | 7.00 | 7.25 | 5.50 | 6.75 |

Of course, the above combined astrological compatibilities may be expressed in percentage terms, as shown in Table IV below.

TABLE IV
Combined Astrological Compatibilities in Percentage Terms (Excerpt)

| | Rat/Aries | Rat/Taurus | Rat/Gemini | Rat/Cancer | Rat/Leo | Rat/Virgo |
|---|---|---|---|---|---|---|
| Rat/Aries | 87.50% | 87.50% | 78.12% | 84.38% | 90.62% | 68.75% |
| Rat/Taurus | 87.50% | 84.38% | 75.00% | 84.38% | 84.38% | 90.62% |
| Rat/Gemini | 78.12% | 75.00% | 84.38% | 78.12% | 84.38% | 75.00% |
| Rat/Cancer | 84.38% | 84.38% | 78.12% | 87.50% | 84.38% | 84.38% |
| Rat/Leo | 90.62% | 84.38% | 84.38% | 84.38% | 87.50% | 87.50% |
| Rat/Virgo | 68.75% | 90.62% | 78.12% | 84.38% | 87.50% | 87.50% |
| Rat/Libra | 84.38% | 68.75% | 90.62% | 75.00% | 84.38% | 75.00% |
| Rat/Scorpio | 68.75% | 84.38% | 68.75% | 90.62% | 84.38% | 78.12% |
| Rat/Sagittarius | 90.62% | 68.75% | 84.38% | 68.75% | 90.62% | 75.00% |
| Rat/Capricorn | 81.25% | 90.62% | 68.75% | 84.38% | 68.75% | 90.62% |
| Rat/Aquarius | 84.38% | 75.00% | 90.62% | 68.75% | 84.38% | 68.75% |

In this alternative embodiment, the searching algorithm will not perform calculation of the combined astrological compatibility, steps 1188, 1190 and 1192, described above, but will instead extract a combined compatibility rate from Table III or Table IV, and display this result to the user.

In the preferred embodiment of the present invention, the results of the above described search are presented to the user in the search results interface 200, shown in FIG. 9. Each displayed result preferably includes a username of the selected person, his/her Chinese and Western signs, contact information and the combined astrological compatibility between the user and the selected person. The system may be programmed to list all matches, with their compatibility rated from 1% to 100% in descending order, or, alternatively, to only display results having a combined compatibility rate higher than a certain threshold level. For example, the algorithm may display the matches whose combined compatibility with the user exceeds 50%. The user has the opportunity to view more information about the found match, contact him/her, or refine the search if a satisfactory match was not found.

In accordance with one aspect of the preferred embodiment of the present invention, a system and method is provided allowing users to search for people who are best compatible with them according to astrological data as calculated by the above described astrological compatibility tables. The system is partially implemented at www.matchspider.com. To operate, the software should preferably have the following input data: searcher's date of birth and dates of birth of people who are searched. The software should also have an access to data sources containing the above demographic data.

Preferably, the searching software has access to dates of birth of all people in the world, and when the date of birth of the searcher is entered, the software returns a list of people who are best compatible with the searcher.

Core or basic function of the searching software performs a search based only on the criteria of astrological compatibility between searcher and person(s) who are being searched. However, having only this search criteria might not be enough for some users. For example, when a searcher cannot filter search results, for example, by age or gender, the search may bring results which are 100% astrologically compatible with the searcher but absolutely not desirable according to other criteria. The astrological compatibility search can be added to existing search tools for dating, matchmaking, find-a-professional (lawyers, accountants, doctors etc.) or any web site designated to connect and/or match people.

In accordance with the preferred embodiment, the search software searches for the best match according to astrological criteria when used as a stand-alone application. When this software is used as a plug-in to other search applications, it also adds astrological criteria to existing search engines. The software can be used as a plug-in for any database search engine-software with minimal or no additional programming.

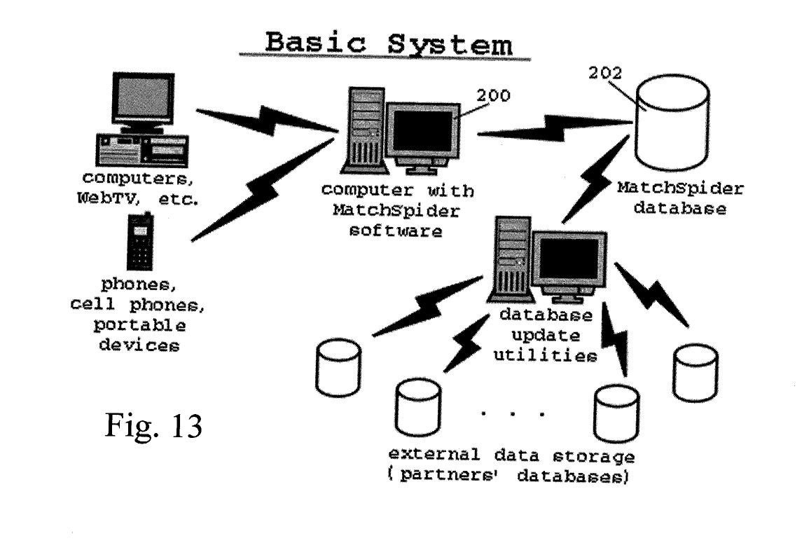

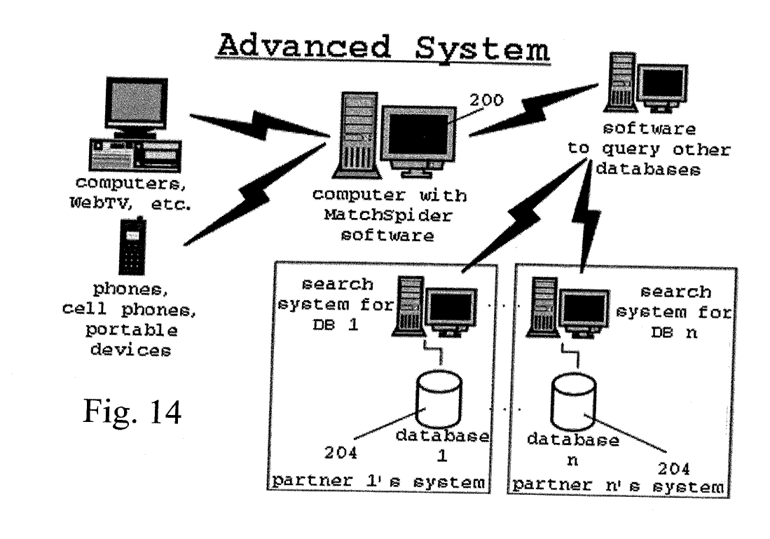

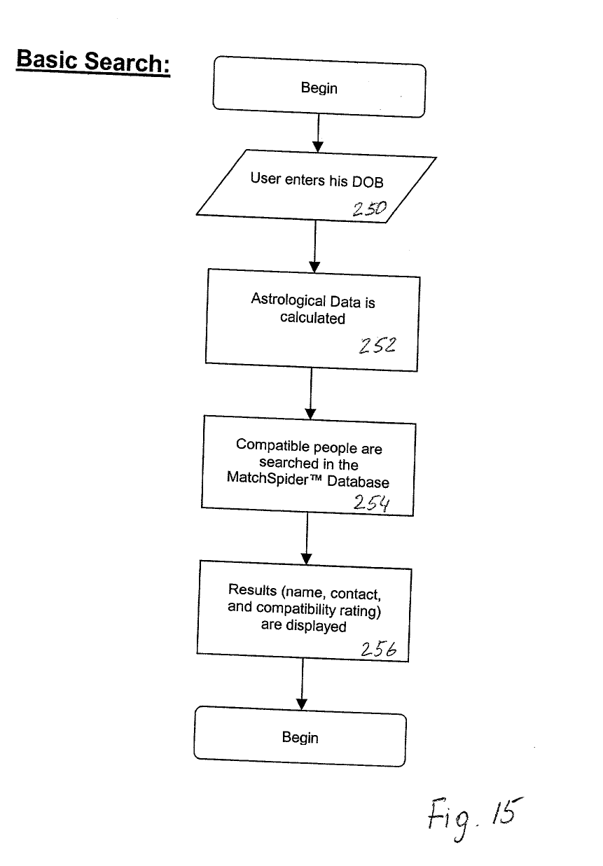

One possible implementation of the software will now be described in connection with one preferred embodiment, as shown in FIGS. 13-16. The system uses a computer (server) 200 connected to the Internet. The core of the system is the above described matchmaking algorithm. It inputs a list of people with their astrological data and outputs this list sorted according to their astrological compatibility. The list is obtained either from the database 202 provided with the server or from any other available database 204. Of course, the speed of the search will be maximized if the server's database 202 is used.

The provided database 202 will preferably contain only three fields with one field defining person's name, astrological information, or contact information. The astrological information should preferably be stored in a special format, for example, 10-digit alphanumerical ID encoding person's astrological signs, elements, aspects and other characteristics. This encoding will ensure the quickest compatibility search and sort times.

The database 202, limited to the described three fields, will be regularly updated by the following means (not limited to the ones listed below):

1. Dating, matchmaking, community sites and any other external entity having a database containing peoples' dates of birth. Additional software will regularly (e.g. daily) update the database 202 by sending new-recorded profiles with dates of birth via e-mail or by other means to the database 202. This software may be installed on every external entity;

2. A web-spider software, preferably the one written by NobleGrace Corporation, i.e., a program that obtains people's records containing date of birth and relevant URLs from various publicly accessible Web resources;

3. Direct users' registrations whose information is entered into the provided database 202 manually.

The basic version of the match searching software preferably consists of the following elements:

The database with three basic fields per record;

Different utilities (e.g. editors) designed to update, maintain and manage this database;

The matchmaking calculator software calculating astrological compatibility calculations between two or more individuals based on their dates of birth (as described in more details above);

The user interface (for example: HTML pages, JAVA applets, telephone connection in telephone dating service, etc.), which receives person's date of birth and outputs astrologically compatible matches.

This basic version will serve the purpose of quick, efficient search of compatible matches. When person receives compatible matches in his/her search results, he/she can click on a provided contact link or a link to the place where more information about the match is available.

The user interface can be implemented as a Web page where users enter their dates of birth and initiate the search by clicking on a search button. The search results, i.e., people's names, astrological information, and contact information (typically a link to a referring web page), may be displayed on the search results web page. This interface will be accessible from any device connected to the Internet. Alternatively, the user interface might be implemented using a telephone system accessible from any touch-tone phone.

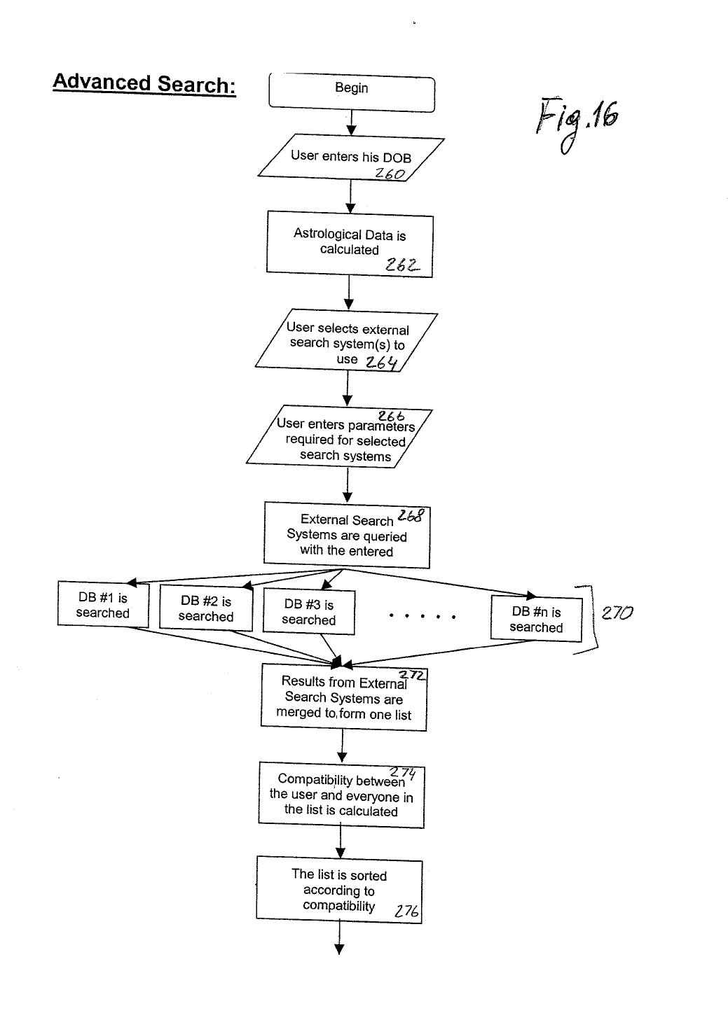

The flow of information within the provided system is shown in FIG. 15. After the user enters his/her birth information, block 250, the astrological information is calculated, block 252. The provided database 202 is searched, block 254, and the most compatible people are found and displayed, block 256.

If the user wants to search by some criteria other than astrological, the provided match searching software may be supplemented by other search programs. Typically, the match searching software will then be utilized as a plug-in for other search systems. In this embodiment of the present invention, each external search system will be provided with at least three “filters”. Filter 1 describes what search parameters are accepted by and should be provided to the external search system. Filter 2 describes how the results of the external search should be interpreted by the match searching software. Filter 3 describes how the data should be presented to the user.

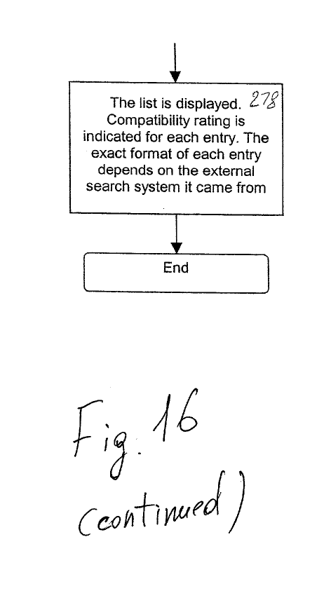

As shown in FIG. 16, the complete match searching software is preferably a stand-alone version along with the described filters for various databases and user interface. One possible user interface is a set of Web pages on the MatchSpider.com or NobleGrace.com websites. On one of the pages, the user enters the date of birth, block 260, and on the next page the user selects an external search system he/she wants to use.

The user's astrological data is calculated, block 262, using the birth data. The set of filters1 for the selected search systems is accessed, block 264, to obtain the list of the parameters these search systems require. The user is sent to another web page with a form where the required parameters should be filled in, block 266. After clicking the submit button, the information is sent to a script on the provided web server. This script connects to the specified search systems over the Internet, and submits queries with the information provided by the user, block 268. Each of the external search systems returns a search result, blocks 270.

Using appropriate filters2, the results from all engines are merged into one result set, block 272, which can be understood by the matching program. This merged result set is then transferred to the match calculating program, block 274, which calculates user's astrological compatibility with each person in the result set, and the result set is then sorted according to this compatibility, block 276. The sorted result set is then transferred to another script that displays it on a web page according to rules in the appropriate filter 3, block 278.

The following example illustrates function of the provided search software. Suppose the user wants to search for the best lawyer in New York area compatible with him/her by horoscope. The user may access the MatchSpider.com web page, and select two or more search systems on the web. Two most popular lawyer search engines are currently www.lawyers.com and www.attomeyfind.com. The filter1 for www.lawyers.com shows that it requires a “city” parameter, and filter1 for www.attomeyfind.com shows that it requires “city” and “area of practice” parameters. Therefore, a web page with two fields to fill in, i.e., the “city” and “area of practice,” will be provided to the searcher. After filling in these fields, the user clicks the submit button. The script submits entered location data to www.lawyers.com and entered location and practice area data to www.attomeyfind.com. Both websites return results, with filter2 for both systems telling the matching software where to find relevant information (i.e., date of birth). The results are merged, sorted, and then passed to the display script. The script displays the data the way filter3 describes it. For example, if filter3 for www.lawyers.com specifies that results should be displayed with yellow background color, the script will do so.

Using filter3 it is possible to make results displayed on the MatchSpider.com web page look exactly the same as they would have been displayed on the originating page. The user might proceed to work with them, as he/she would do on the original web site.

Alternatively, any online search system may add a checkbox “compatible by horoscope” and, if necessary, “DOB.” If the user of the external system checks the box, the information is also sent to MatchSpider.com for processing. For example, any currently available operating system may add the described software to its desktop, preferably as an icon, thus allowing a user to search for his/her astrological match with just one click on the icon. Also, AOL, Yahoo, ICQ, MSN and another instant messengers may add the provided software as a plug-in and when two (or more) people communicate on-line, their astrological compatibility is automatically displayed.

It is also known in the art, to enable hardware devices, e.g. cell-phones, PDAs, laptops, etc., to communicate with each other. The disclosed software may also be added to such communicating devices, such that whenever two users of these devices, who are astrologically compatible, are located within a communication distance from each other, their devices will alert them.

Contrary to the calculating software described above, the calculator of the searching software may calculate the compatibility between two dates of birth without calculating any other astrological data.

Other means for calculating compatibility between people might also be used. For example, as DNA is being decoded, and information about their genome is available to people, it might be used for matchmaking. Given that the genome code contains all the information about us, probably including astrological information, collecting other biographical information to calculate compatibility may become obsolete. If research shows correlation between certain genes and astrological characteristics, compatibility might be calculated between DNA's of two people, thus opening the field of DNA matchmaking.

As mentioned above, the provided searching software can be designed as a stand-alone application or may be applied as a plug-in for other search systems (for example, search engines), adding an ability to search by another criteria, namely astrological compatibility.

The above described method of matchmaking by horoscope may also be realized as a TV show, where participants will be asked their dates of birth and given their combined compatibility with a selected partner. The show may also have an associated database, which may be searched to find an astrologically compatible match in accordance with the above described method. Alternatively, the matchmaking process may be organized as a cyber café, providing access to the Internet and giving users an opportunity to search for a compatible friend or partner among other people in the cafe or in an associated database.

The presently disclosed method of matchmaking may also be empirically tested by asking different couples if the combined compatibility rating obtained using the above method reflects their real relationship with their partners. When enough feedback is obtained the relative weights of the different elements within the combined compatibility calculator formula may be adjusted.

Having described this invention with regard to specific embodiments, it is to be understood that the description is not meant as a limitation since further variations or modifications may be apparent or may suggest themselves to those skilled in the art. It is intended that the present application cover such variations and modifications as fall within the scope of the appended claims.

We claim as follows:

1. A method of searching for a person's astrological match comprising the steps of:
a. obtaining a user's date of birth;
b. connecting to at least one data source, said data source comprising people's dates of birth;
c. obtaining a date of birth of at least one potential match from said data source;
d. calculating an astrological compatibility between said user and said potential match; and
e. displaying said astrological compatibility to said user.

2. A method of searching for a person's astrological match according to claim 1 wherein said step of obtaining said date of birth of said potential match from said data source further comprises a step of searching said data source for said potential match.

3. A method of searching for a person's astrological match according to claim 1, wherein said at least one data source further comprises people's names and people's contact information.

4. A method of searching for a person's astrological match according to claim 1 further comprising calculating astrological data of said user based on said user's date of birth.

5. A method of searching for a person's astrological match according to claim 1 further comprising a step of obtaining additional search parameters from said user.

6. A method of searching for a person's astrological match according to claim 5, wherein said step of calculating an astrological compatibility between said user and said potential match further comprises a step of filtering said astrological compatibility in accordance with said additional search parameters.

7. A method of searching for a person's astrological match according to claim 1, wherein said step of calculating said astrological compatibility between said user and said potential match further comprises the steps of determining a user's combined astrological sign; determining a combined astrological sign of said potential match; and using said combined astrological signs to calculate said astrological compatibility.

8. A method of searching for a person's astrological match according to claim 7, wherein said user's combined astrological sign comprises a Western sign of said user and a Chinese sign of said user.

9. A method of searching for a person's astrological match according to claim 6, wherein said combined astrological sign of said potential match comprises a Western sign of said potential match and a Chinese sign of said potential match.

10. A method of searching for a person's astrological match according to claim 1, wherein said step of calculating an astrological compatibility between said user and said potential match further comprises using said user's and said potential match's unique biological information.

11. A method of searching for a person's astrological match according to claim 10, wherein said unique biological information is a DNA.

12. A method of searching for a person's astrological match according to claim 10, wherein said unique biological information is a fingerprint.

13. A search system for searching for a person's astrological match comprising:
a. input means for entering a user's date of birth;
b. connecting means, said connecting means connecting said system to at least one database, said database comprising people's dates of birth;
c. searching means for searching said database for at least one potential match;
d. calculating means, said calculating means calculating an astrological compatibility between said user and said potential match; and
e. a display, said display displaying said astrological compatibility to said user.
